(19) United States
(12) Patent Application Publication
(10) Pub. No.: US 2026/0006315 A1
(43) Pub. Date: Jan. 1, 2026

(54) IMAGE PROCESSING DEVICE AND IMAGE SENSOR CONTROL METHOD THEREOF

(71) Applicant: SigmaStar Technology Ltd., Xiamen (CN)

(72) Inventors: Wei Sheng DU, Xiamen (CN); Yan Xiong WU, Xiamen (CN)

(21) Appl. No.: 18/973,309

(22) Filed: Dec. 9, 2024

(30) Foreign Application Priority Data
Jun. 28, 2024 (CN) 202410866602.9

(51) Int. Cl. H04N 23/60; H04N 23/81; H04N 23/88

(52) U.S. Cl. CPC H04N 23/64; H04N 23/81; H04N 23/88

(57) ABSTRACT

An image processing device includes a pre-statistical circuit, an image processing circuit and a processor. The pre-statistical circuit receives first image data from a first image sensor, receives second image data from a second image sensor, performs pre-processing according to the first image data to generate first frame data and first statistical data, and performs the pre-processing according to the second image data to generate second frame data and second statistical data. The image processing circuit performs image processing on the first frame data and the second frame data to sequentially generate a first output frame and a second output frame. The processor performs an auto control algorithm according to the first statistical data to adjust the first image sensor, and performs the auto control algorithm according to the second statistical data to adjust the second image sensor.

This application claims the benefit of China application Serial No. CN202410866602.9, filed on June 28, 2024, the subject matter of which is incorporated herein by reference.

### BACKGROUND OF THE INVENTION

### FIELD OF THE INVENTION

The present application relates to an image processing device, and more particularly to an image processing device that enables a parameter configuration of an image sensor to take effect faster and an image sensor control method thereof.

### DESCRIPTION OF THE RELATED ART

In the prior art, if image data of multiple sensors are processed by a same image signal processor, the image signal processor needs to read the image data from a memory after the image data of the image sensors is written to the memory, and accordingly perform a related control algorithm to determine whether a parameter configuration of a certain image sensor is to be adjusted. As such, the image sensor needs to wait for at least two frame periods before it can generate new image data by using the adjusted parameter configuration. The control means above contains a delay of the at least two frames and is thus unsuitable for application scenarios with higher real-time requirements for image capturing.

### SUMMARY OF THE INVENTION

In some embodiments, it is an object of the present application to provide an image processing device that enables a parameter configuration of an image sensor to take effect faster and an image sensor control method thereof, so as to improve the issues of the prior art.

In some embodiments, an image processing device includes a pre-statistical circuit, an image processing circuit and a processor. The pre-statistical circuit receives first image data from a first image sensor, receives second image data from a second image sensor, performs pre-processing according to the first image data to generate first frame data and first statistical data, and performs the pre-processing according to the second image data to generate second frame data and second statistical data. The image processing circuit performs image processing on the first frame data and the second frame data to sequentially generate a first output frame and a second output frame. The processor performs an auto control algorithm according to the first statistical data to adjust the first image sensor, and performs the auto control algorithm according to the second statistical data to adjust the second image sensor.

In some embodiments, an image sensor control method, performed by an image processing device, includes: receiving first image data from a first image sensor, receiving second image data from a second image sensor, performing pre-processing according to the first image data to generate first statistical data, and performing the pre-processing according to the second image data to generate second statistical data; performing an auto control algorithm according to the first statistical data to adjust the first image sensor, and performing the auto control algorithm according to the second statistical data to adjust the second image sensor; and controlling the adjusted first image sensor to generate third image data, wherein the third image data differs from the first image data by one frame period.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1A is a schematic diagram of adjusting timings of multiple image sensors according to some related art;

FIG. 1B is a schematic diagram of adjusting timings of multiple image sensors according to some embodiments of the present application;

FIG. 2 is a schematic diagram of an image processing device according to some embodiments of the present application;

FIG. 3 is an operation flowchart of the image processing device in FIG. 2 according to some embodiments of the present application;

FIG. 4 is a schematic diagram of the pre-statistical circuit in FIG. 2 according to some embodiments of the present application; and

FIG. 5 is a flowchart of an image sensor control method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

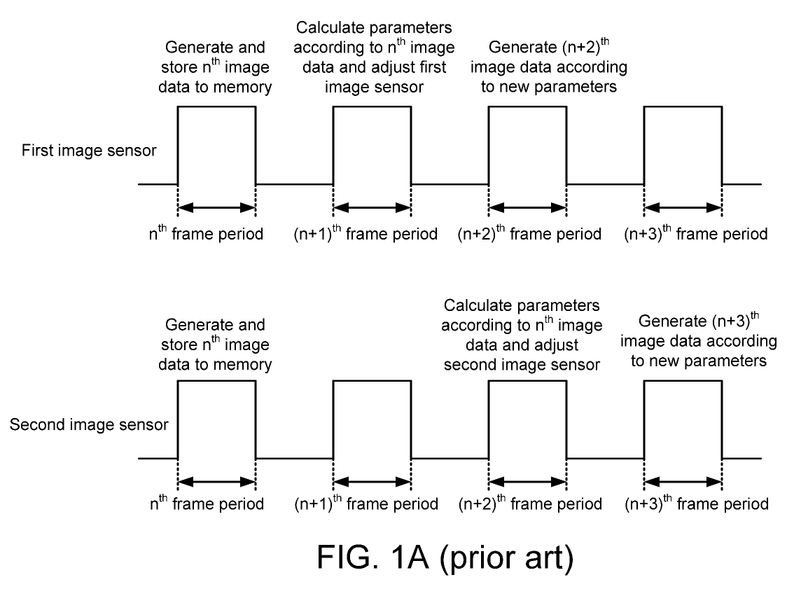

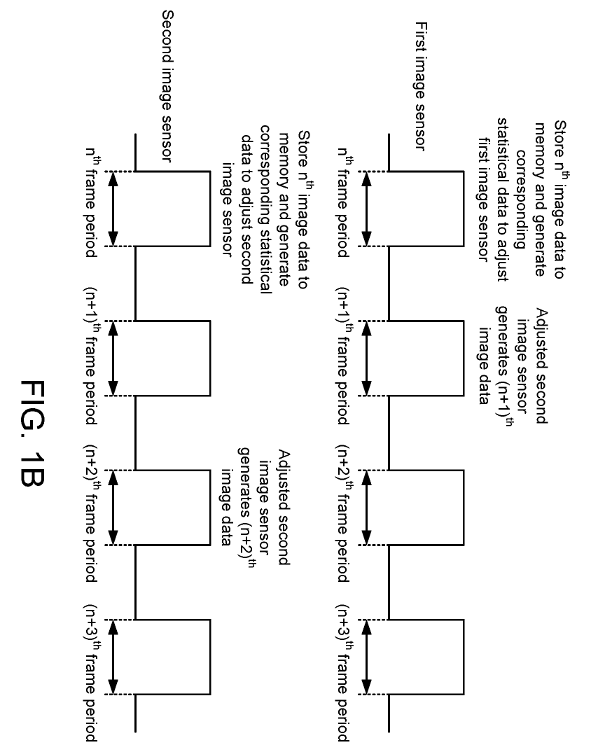

FIG. 1A shows a schematic diagram of adjusting timings of multiple image sensors according to some related art. In some related art, if image data of multiple image sensors is processed by a same image processor, adjustment made on the image sensors takes effect only after at least two frame periods. As shown in FIG. 1A, after n^{th} image data of a first image sensor is written to a memory at an n^{th} frame period, the image processor calculates related parameters according to the n^{th} image data in an (n+1)^{th} frame period, and accordingly adjusts the first image sensor. Thus, the adjusted first image sensor generates image data corresponding to new parameters in an (n+2)^{th} frame period. On the other hand, the n^{th} image data of a second image sensor is also stored to the memory in the n^{th} frame period. Since the first and second image sensors share the same image processing circuit, the image processing circuit can calculate the related parameters according to the n^{th} image data of the second image sensor only in the (n+2)^{th} frame period, and accordingly adjust the second image sensor. Thus, the adjusted second image sensor can generate image data corresponding to new parameters only in an (n+3)^{th} frame period. Hence, it can be understood that, the control method of related techniques needs at least two frame periods in order to adjust an image sensor, and is incapable of adjusting related parameters of an image sensor in real time and is unsuitable for application scenarios with higher real-time requirements for image capturing.

FIG. 1B shows a schematic diagram of adjusting timings of multiple image sensors according to some embodiments of the present application. Compared to the prior art above, in some related embodiments of the present application, a pre-statistical circuit is configured to determine corresponding statistical data according to n^{th} image data of a first image sensor in an n^{th} frame period, such that a processor is allowed to determine control parameters of a first image sensor according to the statistical data in the same period and accordingly adjust the first image sensor. Thus, the adjusted first image sensor can generate (n+1)^{th} image data corresponding to new parameters in an (n+1)^{th} frame period. That is, the (n+1)^{th} image data generated by the adjusted first image sensor differs from the n^{th} image data by one frame period. Similarly, the pre-statistical circuit may determine corresponding statistical data according to n^{th} image data of a second image sensor in the n^{th} frame period, such that the processor is allowed to determine control parameters of the second image sensor according to the statistical data in the same period and accordingly adjust the second image sensor. Thus, the adjusted second image sensor can generate adjusted (n+2)^{th} image data in an (n+2)^{th} frame period. That is, the (n+2)^{th} image data generated by the adjusted second image sensor differs from the original n^{th} image data by two frame periods. Compared to FIG. 1A, the control means above enables the first and second image sensors to each save delays of at least one frame period, and is thus more suitable for application scenarios with higher real-time requirements for image capturing.

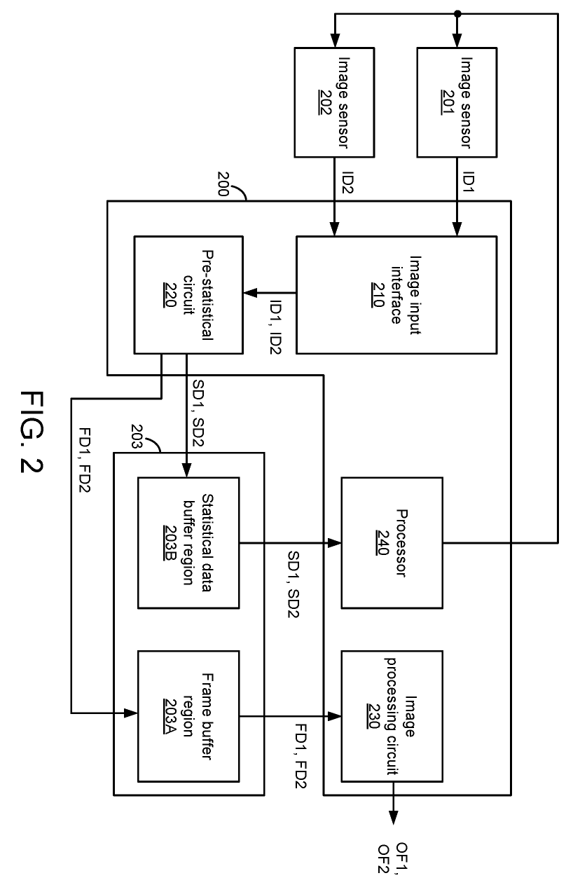

FIG. 2 shows a schematic diagram of an image processing device 200 according to some embodiments of the present application. An image processing device 200 includes an image input interface 210, a pre-statistical circuit 220, an image processing circuit 230 and a processor 240. The image input interface 210 is coupled to an image sensor 201 and an image sensor 202 to receive image data ID1 generated by the image sensor 201 and image data ID2 generated by the image sensor 202. In some embodiments, the image input interface 210 may include a register and/or a mobile industry processor interface (MIPI); however, the present application is not limited to the examples above.

The pre-statistical circuit 220 may receive the image data ID1 and the image data ID2 from the image sensor 201 and the image sensor 202, respectively, perform pre-processing according to the image data ID1 to generate frame data FD1 and statistical data SD1, and perform the pre-processing according to the image data ID2 to generate frame data FD2 and statistical data SD2. In some embodiments, information carried in the statistical data SD1 and the statistical data SD2 are related information for the processor 240 to perform an auto control algorithm, for the processor 240 to accordingly adjust related parameters of the image sensor 201 and the image sensor 202. In some embodiments, the auto control algorithm above may be a 3A algorithm, which may include at least one of an auto exposure algorithm, an auto white balance algorithm and/or an auto focus algorithm. In some embodiments, the statistical data SD1 includes at least one of red channel data, green channel data, blue channel data, histogram data and/or focal distance information corresponding to the image data ID1. For example, the pre-statistical circuit 220 may divide the image data ID1 into multiple image blocks, sequentially calculate red data average value, green data average value, blue data average value and luminance average value in each image block, and accordingly generate the red channel data, the green channel data, the blue channel data and histogram data. In some embodiments, the statistical data SD2 may include at least one of red channel data, green channel data, blue channel data, histogram data and/or focal distance information corresponding to the image data ID2.

The type of the auto control algorithm and the type of information carried in the statistical data SD1 (and the statistical data SD2) are merely examples, and the present application is not limited thereto. Specific operation details related to the 3A algorithm may be referred from existing mathematic models related to the auto exposure algorithm, the auto white balance algorithm and the auto focus algorithm, and are omitted herein.

The pre-statistical circuit 220 may store the frame data FD1 and the frame data FD2 to a frame buffer region 203A of the memory 203, and store the statistical data SD1 and the statistical data SD2 to a data buffer region 203B of the memory 203. In some embodiments, the memory 203 may be a dynamic random access memory (DRAM); however, the present application is not limited thereto. In some embodiments, the pre-statistical circuit 220 at the same time performs processing and calculation on the image data ID1 while receiving the image data ID1, and at the same time transmits the frame data FD1 to the memory 203. Thus, the pre-statistical circuit 220, upon completely receiving the complete image data ID1, is close to completely transmitting the statistical data SD1 and close to completely transmitting the frame data FD1 to the memory 203. For example, while a first image sensor transmits n^{th} image data to the pre-statistical circuit 220, the pre-statistical circuit 220, upon receiving partial data of the n^{th} image data each time, immediately performs processing and calculation on the partial data, and the processed partial data becomes partial data of the frame data FD1 and is immediately transmitted to the memory 203. The first image sensor transmits the n^{th} image data to the pre-statistical circuit 220 in one frame period, the pre-statistical circuit 220 completes most of the processing and calculation operations on the n^{th} image data in the same frame period, and most of the image data FD1 is transmitted to the memory 203 in the same frame period. In practice, the pre-statistical circuit 220 is able to complete 90% or more of the processing and calculation operations on the n^{th} image data in the same frame period, and transmit 90% or more of the frame data FD1 to the memory 203 in the same frame period, and at the same time performs operations including receiving the image data ID1, performing processing and calculation on the image data ID1 and transmitting the frame data FD1 to the memory 203, hence significantly enhancing the overall processing efficiency of the image processing device 200. Similarly, the pre-statistical circuit 220 at the same time performs processing and calculation on the image data ID2 while receiving the image data ID2, and at the same time transmits the frame data FD2 to the memory 203. Thus, the pre-statistical circuit 220, upon completely receiving the complete image data ID2, is close to completely transmitting the statistical data SD2 and close to completely transmitting the frame data FD2 to the memory 203.

The image processing circuit 230 may be an image signal processor, which may obtain the frame data FD1 and the frame data FD2 from the memory 203, and perform image processing on the frame data FD1 and the frame data FD2 to sequentially generate an output frame OF1 and an output frame OF2. In some embodiments, the image processing circuit 230 may provide the output frame OF1 and the output frame OF2 to a display device so as to display image contents of the output frame OF1 and the output frame OF2.

The processor 240 may obtain the statistical data SD1 from the memory 203 and perform the auto control algorithm above according to the statistical data SD1, so as to determine an amount of adjustment for the image sensor 201 and accordingly adjust the image sensor 201. For example, the processor 240 may perform an auto control algorithm according to the statistical data SD1 to configure at least one of an auto exposure gain, an auto white balance gain and a focal distance of the image sensor 201, and configure a digital gain in the image processing circuit 230 for processing the image data generated by the image sensor 201. As such, as shown in FIG. 1B, the adjusted image sensor 201 (for example, a first image sensor) may generate next image data according to the updated related configuration, wherein the next image data and the image data ID1 can differ merely by one frame period. Similarly, the processor 240 may obtain the statistical data SD2 from the memory 203 and perform the auto control algorithm above according to the statistical data SD2, so as to determine an amount of adjustment for the image sensor 202 and accordingly adjust the image sensor 202. Correspondingly, the processor 240 may perform an auto control algorithm according to the statistical data SD2 to configure at least one of an auto exposure gain, an auto white balance gain and a focal distance of the image sensor 202, and configure a digital gain in the image processing circuit 230 for processing the image data generated by the image sensor 202. As such, as shown in FIG. 1B, the adjusted image sensor 202 (for example, a second image sensor) may generate next image data according to the updated related configuration, wherein the next image data and the image data ID2 can differ merely by two frame periods.

As described with reference to FIG. 1B, while the image data ID1 generated by the image sensor 201 (for example, the first image sensor in FIG. 1B) and the image data ID2 generated by the image sensor 202 (for example, the second image sensor in FIG. 1B) are being stored to the memory 203 (for example, during an n^{th} frame period), the statistical data SD1 corresponding to the image data ID1 and the statistical data SD2 corresponding to the image data ID2 may be generated at the same time. Further, in some embodiments, before the image data ID1 and the image data ID2 are completely stored to the memory 203, the pre-statistical circuit 220 may generate the statistical data SD1 and the statistical data SD2. Thus, the statistical data SD1 is generated before the image processing circuit 230 starts processing the image data FD1 and the statistical data SD2 is generated before the image processing circuit 230 starts processing the image data FD2, such that the processor 240 is allowed to evaluate control parameters of the image sensor 201 according to the statistical data SD1 and evaluate control parameters of the image sensor 202 according to the statistical data SD2 at earlier timings, thereby enhancing adjustment efficiency of the image sensor 201 and the image sensor 202.

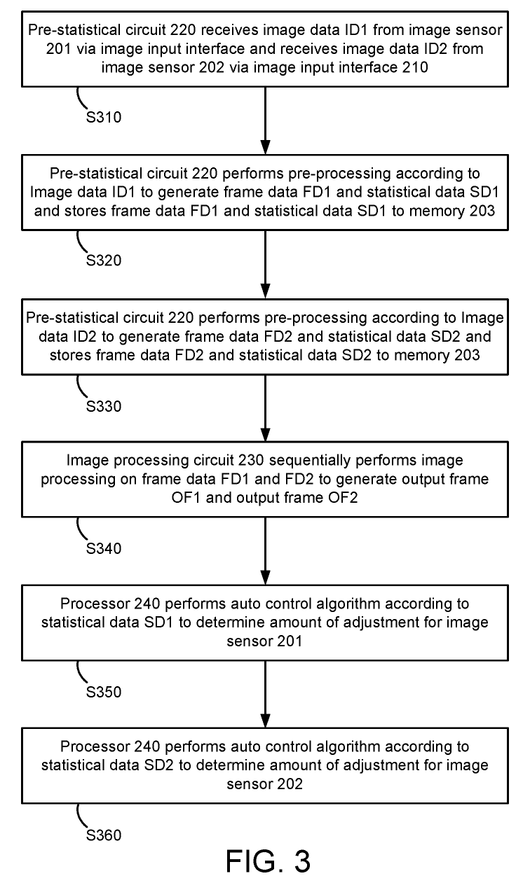

FIG. 3 shows an operation flowchart of the image processing device 200 in FIG. 2 according to some embodiments of the present application. In operation S310, the pre-statistical circuit 220 receives the image data ID1 from the image sensor 201 via the image input interface 210, and receives the image data ID2 from the image sensor 202 via the image input interface 210. In operation S320, the pre-statistical circuit 220 performs pre-processing according to the image data ID1 to generate the frame data FD1 and the statistical data SD1, and stores the frame data FD1 and the statistical data SD1 to the memory 203. In operation S330, the pre-statistical circuit 220 performs pre-processing according to the image data ID2 to generate the frame data FD2 and the statistical data SD2, and stores the frame data FD2 and the statistical data SD2 to the memory 203. In operation S340, the image processing circuit 230 sequentially performs image processing on the frame data FD1 and the frame data FD2 to sequentially generate the output frame OF1 and the output frame OF2. In operation S350, the processor 240 performs an auto control algorithm according to the statistical data SD1 so as to determine an amount of adjustment for the image sensor 201. In operation S360, the processor 240 performs an auto control algorithm according to the statistical data SD2 so as to determine an amount of adjustment for the image sensor 202.

It should be understood that, the multiple operations above are not limited to being performed in the order shown in FIG. 3. In practice, all or some of the multiple operations above may be performed simultaneously to thereby reduce the time needed for adjusting multiple image sensors.

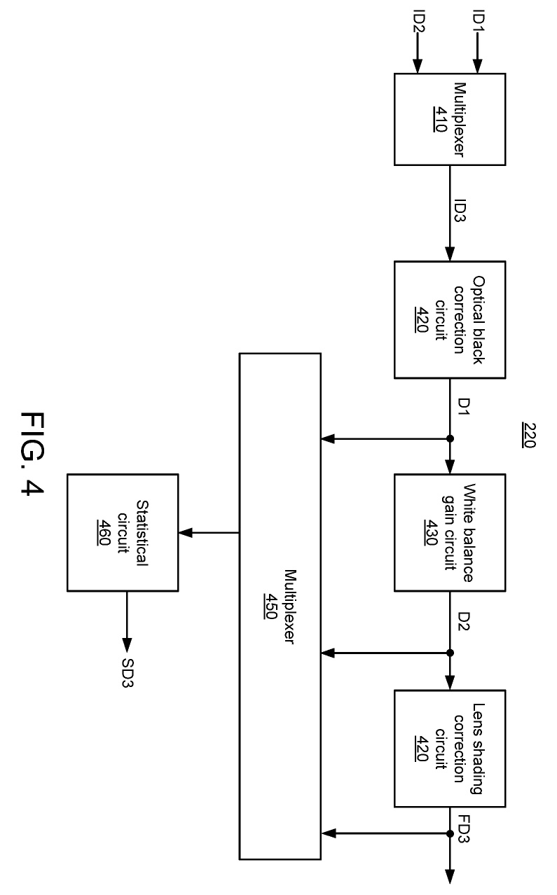

FIG. 4 shows a schematic diagram of the pre-statistical circuit 220 in FIG. 2 according to some embodiments of the present application. In some embodiments, the pre-statistical circuit 220 includes a multiplexer 410, an optical black correction circuit 420, a white balance gain circuit 430, a lens shading correction circuit 440, a multiplexer 450 and a statistical circuit 460.

The multiplexer 410 outputs the image data ID1 and the image data ID2 as corresponding image data ID3. The optical black correction circuit 420 may perform an optical black correction algorithm according to the corresponding image data ID3 to correct a least potential value of black data in the corresponding image data ID3 and accordingly generate data D1. The white balance gain circuit 430 may perform a white balance gain algorithm according to the data D1 to estimate channel data (or component data) of each color (for example, red, green and blue) in the corresponding image data ID3 and accordingly generate data D2. In some embodiments, by performing the white balance gain algorithm on the data D1 having undergone the optical black correction algorithm, more accurate white balance information can be obtained. The lens shading correction circuit 440 may perform a lens shading correction algorithm according to the data D2 to correct distortion and/or imaging errors in the corresponding image data ID3 caused by a lens and accordingly generate corresponding frame data FD3 in frame data FD1 and frame data FD2. The multiplexer 450 outputs one of data D1, the data D2 and the corresponding frame data FD3 to the statistical circuit 460. The statistical circuit 460 generates corresponding statistical data SD3 in the statistical data SD1 and the statistical data SD2 according to the data D1, the data D2 or the corresponding frame data FD3. In some embodiments, the multiplexer 410 and the multiplexer 450 may set outputs and timings thereof by pre-configured control signals. In some embodiments, the multiplexer 410 and the multiplexer 450 may be controlled by the processor 240 in FIG. 2.

It should be understood that, for example, when the corresponding image data ID3 is the image data ID1, the corresponding frame data FD3 may be the frame data FD1, and the corresponding statistical data SD3 is the statistical data SD1. Similarly, when the corresponding image data ID3 is the image data ID2, the corresponding frame data FD3 may be the frame data FD2, and the corresponding statistical data SD3 is the statistical data SD2. The statistical circuit 460 may perform one or more statistical operations according to the data D1, the data D2 or the corresponding frame data FD3 to obtain at least one of the red channel data, the green channel data, the blue channel data, the histogram data and/or the focal distance information described above corresponding to the image data ID1 (or the image data ID2), and accordingly output the same as the corresponding statistical data SD3.

Specific operation details of the optical black correction algorithm, the white balance gain algorithm and the lens shading correction algorithm above may be referred from related mathematical models in the prior art, and such details are omitted herein. It should be understood that, the optical black correction algorithm, the white balance gain algorithm and the lens shading correction algorithm and the related estimations performed by the statistical circuit 460 above are all encompassed within the pre-processing performed by the pre-statistical circuit 220; however, the present application is not limited to the operations above and/or the algorithms above. Various algorithms and operations that may be used to assist the processor 240 to configure and/or control related parameters of the image sensor 201 and the image sensor 202 are encompassed within the pre-processing performed by the pre-statistical circuit 220.

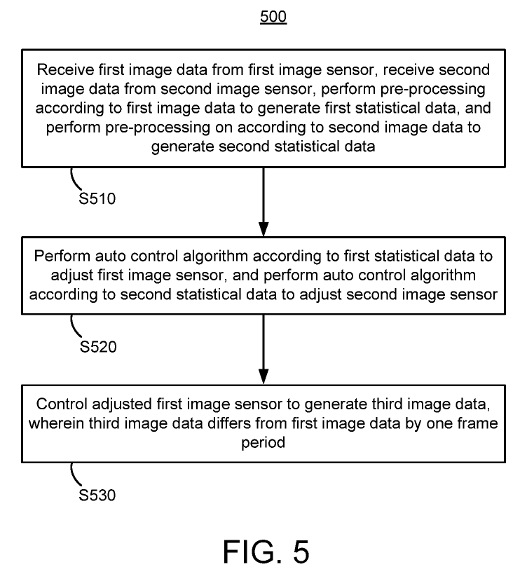

FIG. 5 shows a flowchart of an image sensor control method 500 according to some embodiments of the present application. In some embodiments, the image sensor control method 500 may be performed by, for example but not limited to, an image processing device (for example, the image processing device 200 in FIG. 2). In operation S510, first image data is received from a first image sensor, second image data is received from a second image sensor, pre-processing is performed according to the first image data to generate first statistical data, and the pre-processing is performed according to the second image data to generate second statistical data. In operation S520, an auto control algorithm is performed according to the first statistical data to adjust the first image sensor, and the auto control algorithm is performed according to the second statistical data to adjust the second image sensor. In operation S530, the adjusted first image sensor is controlled to generate third image data, wherein the third image data differs from the first image data by one frame period.

Details associated with the multiple operations of the image sensor control method 500 above can be referred from the details of the multiple embodiments above, and such repeated details are omitted herein. The multiple operations above are merely examples, and are not limited to being performed in the order specified in this example. Without departing from the operation means and ranges of the various embodiments of the present application, additions, replacements, substitutions or omissions may be made to the operations of the image sensor control method 500, or the operations may be performed in different orders. Alternatively, all or some of one or more the operations in the image sensor control method 500 may be performed simultaneously.

In conclusion, the image processing device and the image sensor control method provided according to some embodiments of the present application are capable of generating statistical data of multiple image sensors at earlier timings when the multiple image sensors share one image processing circuit, allowing the processor to more quickly determine configuration parameters of these image sensors according to the statistical data and accordingly adjust these image sensors. Thus, related configuration parameters of the multiple image sensors may take effect faster so as to more real-time generate new image data according to the adjusted configuration parameters.

While the present application has been described by way of example and in terms of the preferred embodiments, it is to be understood that the disclosure is not limited thereto. Various modifications may be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. An image processing device, comprising:
a pre-statistical circuit, receiving first image data from a first image sensor, receiving second image data from a second image sensor, performing pre-processing according to the first image data to generate first frame data and first statistical data, and performing the pre-processing according to the second image data to generate second frame data and second statistical data;
an image processing circuit, performing image processing on the first frame data and the second frame data to sequentially generate a first output frame and a second output frame; and
a processor, performing an auto control algorithm according to the first statistical data to adjust the first image sensor, and performing the auto control algorithm according to the second statistical data to adjust the second image sensor.

2. The image processing device according to claim 1, wherein the auto control algorithm comprises at least one of an auto exposure algorithm, a white balance algorithm and an auto focus algorithm.

3. The image processing device according to claim 1, wherein the pre-statistical circuit comprises:
an optical black correction circuit, performing an optical black correction algorithm according to corresponding image data in the first image data and the second image data to generate first data;
a white balance gain circuit, performing a white balance gain algorithm according to the first data to generate second data;
a lens shading correction circuit, performing a lens shading correction algorithm according to the second data to generate corresponding frame data in the first frame data and the second frame data; and
a statistical circuit, generating corresponding statistical data in the first statistical data and the second statistical data according to the first data, the second data or the corresponding frame data.

4. The image processing device according to claim 3, wherein the pre-statistical circuit further comprises:
a first multiplexer, outputting one of the first image data and the second image data as the corresponding image data; and
a second multiplexer, outputting one of the first data, the second data and the corresponding frame data to the statistical circuit.

5. The image processing device according to claim 1, wherein the pre-statistical circuit stores the first frame data, the second frame data, the first statistical data and the second statistical data to a memory, the image processing circuit obtains the first frame data and the second frame data from the memory, and the pre-statistical circuit generates the first statistical data and the second statistical data before the first frame data and the second frame data are stored to the memory.

6. The image processing device according to claim 1, wherein the pre-statistical circuit receives the first image data from the first image sensor via an image input interface, wherein the image input interface receives the first image data from the first image sensor within one frame period, and the pre-statistical circuit completes 90% or more of the pre-processing performed on the first image data in the same frame period and stores 90% or more of the first frame data into a memory.

7. The image processing device according to claim 1, wherein the first image sensor after being adjusted by the processor further generates third image data, and the third image data differs from the first image data by one frame period.

8. The image processing device according to claim 1, wherein the second image sensor after being adjusted by the processor further generates fourth image data, and the fourth image data differs from the second image data by two frame periods.

9. An image sensor control method, performed by an image processing device, the image sensor control method comprising:
receiving first image data from a first image sensor, receiving second image data from a second image sensor, performing pre-processing according to the first image data to generate first statistical data, and performing the pre-processing according to the second image data to generate second statistical data;
performing an auto control algorithm according to the first statistical data to adjust the first image sensor, and performing the auto control algorithm according to the second statistical data to adjust the second image sensor; and
controlling the adjusted first image sensor to generate third image data, wherein the third image data differs from the first image data by one frame period.

10. The image sensor control method according to claim 9, wherein the performing of the pre-processing according to the first image data further generates first frame data, and the image sensor control method further comprises:
storing the first frame data to a memory;
wherein, the receiving of the first image data from the first image sensor is completed within one frame period, 90% or more of the pre-processing performed on the first image data is completed and 90% or more of the first frame data is stored into the memory in the same frame period.
